(19) United States
(12) Patent Application Publication
(10) Pub. No.: US 2008/0050551 A1
(43) Pub. Date: Feb. 28, 2008

(54) FLEXIBLE SUBSTRATE OR LAMINATE AND METHOD OF FORMING AND USING SAME

(75) Inventors: Robert J. Cleereman, Midland, MI (US); Jeffrey D. Wenzel, Saginaw, MI (US); Joseph A. Langmaid, Caro, MI (US); Chad Schuette, Midland, MI (US); Michael E. Hus, Midland, MI (US); Steven A. Sell, Midland, MI (US); Brent A. Salamon, Midland, MI (US)

Correspondence Address: DOBRUSIN & THENNISCH PC, 29 W LAWRENCE ST, SUITE 210, PONTIAC, MI, 48342, US

(73) Assignee: Dow Global Technologies Inc.

(21) Appl. No.: 11/466,842

(22) Filed: Aug. 24, 2006

(51) Int. Cl. B32B 5/00; B29C 39/14

(52) U.S. Cl. 428/98; 264/165

(57) ABSTRACT

The present invention provides a laminate structure. The laminate structure includes a peripheral edge, an internal edge or both. Trim can be provided at the edges.

### TECHNICAL FIELD

This invention relates to a laminate that can be used for multiple purposes, but which is particularly useful for covering portions of an article of manufacture (e.g., electronic articles such as cellular phones). The invention is also directed to a method of forming and/or using the laminate. Such a laminate can be produced to include a desirable aesthetic appearance, integral attachments, molded edges, desired openings or patterns, relatively high durability, combinations there or the like.

### BACKGROUND OF THE INVENTION

Laminates and other substrates can serve multiple purposes. Of particular interest to the present invention is the formation of aesthetically desirable laminates, which can be employed as coverings, supports or the like. Formation of such laminates can present an array of difficulties and challenges.

As one example, it is often desirable for a laminate to include one or more attachments, which allow an individual to secure the laminate to an article of manufacture. Generally, it is desirable for such attachments to have one or more desirable characteristics such as durability, desirable aesthetics, ease of use, low cost, or the like. However, industry has found it difficult to form such attachments and maintain desired balances of these characteristics.

As another example, it can be desirable to provide a laminate with trim about one or more of its edges. However, such trim has presented industry with difficulties since provision of such trim can be exacting and often leaves little room for inaccuracies. Moreover, provision of such trim can be expensive and can be difficult to provide with consistency and/or durability.

Accordingly, the present invention provides a substrate or laminate that overcomes one or more of the aforementioned difficulties or others as will become clear upon reading the description below.

### SUMMARY OF THE INVENTION

Accordingly, a substrate or laminate is disclosed. Typically, the substrate or laminated can be employed as a covering for a article of manufacture such as an electronic device. The covering includes as least one layer and preferably includes a first layer laminated to a second with an adhesive. The covering also typically includes a trim molded about one or more edges of the layer or laminate. The covering can also include attachments, which in one preferred embodiment, comprise molded plastic protrusions having a base portion located between the first and second layer of the laminate.

### BRIEF DESCRIPTION OF THE DRAWINGS

FIG. 1 is a side view of a layer being screen printed according to an exemplary aspect of the present invention.

FIG. 2 is a front view of an exemplary laminate according to an aspect of the present invention.

FIG. 3 is a side view of an exemplary cutting (e.g., slitting) operation according to an aspect of the present invention.

FIG. 4 is an exemplary side view of an exemplary cutting and molding operation according to an aspect of the present invention. FIG. 4A is a sectional view of the exemplary molding operation of FIG. 4.

FIG. 5 is a side view of an exemplary lamination process according to an aspect of the present invention.

FIG. 6A is a side view of an exemplary molding and/or cutting operation according to an aspect of the present invention.

FIG. 6B is a sectional view of part of another exemplary molding operation being performed in accordance with an aspect of the present invention.

FIG. 7 is a perspective view of an exemplary laminate according to an aspect of the present invention,

FIG. 8A is a sectional view of a portion of an exemplary laminate that includes edge trim according to an aspect of the present invention.

FIG. 8B is another sectional view of a portion of an exemplary laminate that includes edge trim according to an aspect of the present invention.

FIG. 8C-8E are still other sectional views of portions of exemplary laminates that include edge trim according to an aspect of the present invention.

FIG. 9A-9D are additional sectional views of portions of exemplary laminates that include edge trim according to an aspect of the present invention.

FIGS. 10A-13C are sectional views of portions of exemplary laminate with edge trim fastened to articles of manufacture according to an aspect of the present invention.

FIGS. 14A-14C are sectional views of exemplary attachments being integrated with a layer or laminate according to an aspect of the present invention.

FIGS. 15A-15C are sectional view of exemplary laminates having trim according to an aspect of the present invention.

### DETAILED DESCRIPTION

The present invention is predicated upon the provision of a laminate and a method of forming and/or using the laminate. The laminate typically includes at least one layer of material, but preferably two or more layers of material, which are laminated together. The laminate can additionally include a polymeric trim attached and extending along one or more edges of the layer[s]. The laminate may be used as covering for a wide variety of articles of manufacture including, without limitation, electronic components (e.g., cell or wireless phones, radios, computers and computer peripherals or the like), automotive vehicle interior components, appliances, tools, instruments or the like. It is often desirable for the laminate to include one or more attachments such that it can be attached to these articles of manufacture. The laminate may also be employed as a stand alone item, with or without attachments, for use as, for example, a mouse pad, a drink coaster or the like.

The laminates of the present invention may also be used for consumer electronics such as PDAs; notebook and desktop computers; headsets; audio equipment such as disc players, MP3 players; video equipment such as televisions and remote DVD players or other types of consumer electronics. The laminates may also be used in premium packaging such as packaging for cosmetics, disc storage units or the like. It is also contemplated that the laminates may be used for appliances or household goods such as laundry machines, lamps, furniture, refrigerators or the like. Moreover, the laminates can be employed in automotive applications such as for door panels, trim panels, instrument panels, automotive consoles, headliners, close-out panels, visors, combinations thereof or the like.

It is also contemplated that the laminates can include flexible, semi-rigid or rigid layers in the form of metal layers (e.g., metal foils) and that such layers may be contoured. Such laminates can thus be used for EMI shielding or can include electronic circuits integrated with or in the laminates.

The process of forming the laminate typically includes one or more of the following steps:
1) provision of two or more layers of material such as fabrics or polymeric materials;
2) attaching one or more attachments to at least one of the two or more layers of material;
3) lamination of the two or more layers to each other with an adhesive and/or other technique for forming a laminate;
4) shaping the laminate according to a predetermined pattern such that the fabric laminate has a predefined peripheral edge and/or one or more through-holes extending through the laminate, wherein, when included, the one or more through-holes are defined by an internal edge; and
5) molding a polymeric trim about the peripheral edge and/or the internal edge, wherein, optionally, during molding, the two or more fabrics become de-laminated from each other at the peripheral edge and/or and the internal edge such that an edge of each of the two or more fabrics is separately enveloped by the polymeric trim.

Of course, the steps above may be performed in any order that is feasible to provide the desired laminate structure. Moreover, part of a first step may be performed before part or the whole of another step is performed followed by another part or completion of the first step. It is also contemplated that two or more of the steps may be formed partially or substantially entirely simultaneously.

White the discussion herein frequently refers to a laminate, it is contemplated that the present invention can be a laminate comprised of a singular layer or substrate of material with the polymeric trim molded about one or more of its edges or the process of forming such a laminate. Thus, it should be understood that reference to the laminate is intended to refer to two or more layers laminated together, however, the discussions of the laminate can be equally applied to a singular layer or substrate with polymeric trim material molded about the layer or substrate.

Layers

Multiple different materials may be used for the layers of the present invention. As one example, the materials can include or be substantially entirely formed of polymeric materials such as thermoplastics, thermosets, elastomers, combinations thereof or the like which can be provided as films or otherwise. It is also contemplated that the materials, which may or may not be polymeric, can be provided as foams or cushion materials. Still other materials can include wood laminates, foils (e.g., metal foils), foams, cushion materials or the like.

In certain preferred embodiments, one, two or more layers are provided as fabrics. As used herein, a fabric can generally include any combination of fibers such a woven fibers, rovings, mattes, agglomerations of fibers or otherwise. Fabric can also include faux and synthetic fabrics. Examples of fabrics can include, without limitation, knits, weaves, suede (e.g., ultrasuede), leather, cotton, synthetic fabric, denim, polyester fabrics, spandex, faux leather or suede, cashmere, nylon fabrics, combinations thereof or the like.

The suitable fabric materials can also include any types of textiles or textile-like materials such as, woven, non-woven, and knit fabrics from natural or synthetic fibers/materials including coagulated polyurethane laminates, PVC and other rigid or flexible film or sheet materials. The suitable “fabrics” may include laminates and structures combining two or more of the aforementioned materials. As one example of combined material, a fabric can include a material such a synthetic leather formed of a polymeric material (e.g., polyurethane) layered with a fibrous material such as a woven or unwoven fabric formed of polymeric (e.g., polyamide) or other strands or fibers. Although, the fabric may be partially or substantially rigid, it is typically preferable for the fabric to be “generally flexible” such that it does not typically return to a predetermined shape or configuration on its own after it is bent or otherwise deformed.

It is generally preferred, although not required, that the one or more of the layers have an aesthetically desirable appearance. The material of the layers may have a naturally desirable aesthetic appearance or may be treated to have such an appearance. The material may be dyed, textured, light treated, woven, roughed, washed, faded, pigmented, combinations thereof or otherwise treated to include a desirable color, pattern, texture or the like.

In one embodiment, the one or more of the layers is printed with a predetermined pattern using a screen printing or other printing technique. Such printing can take place before or after lamination or at any other suitable time depending on when it is most convenient to the particular steps being used. In one preferred embodiment, at least one of the layers is printed prior to lamination.

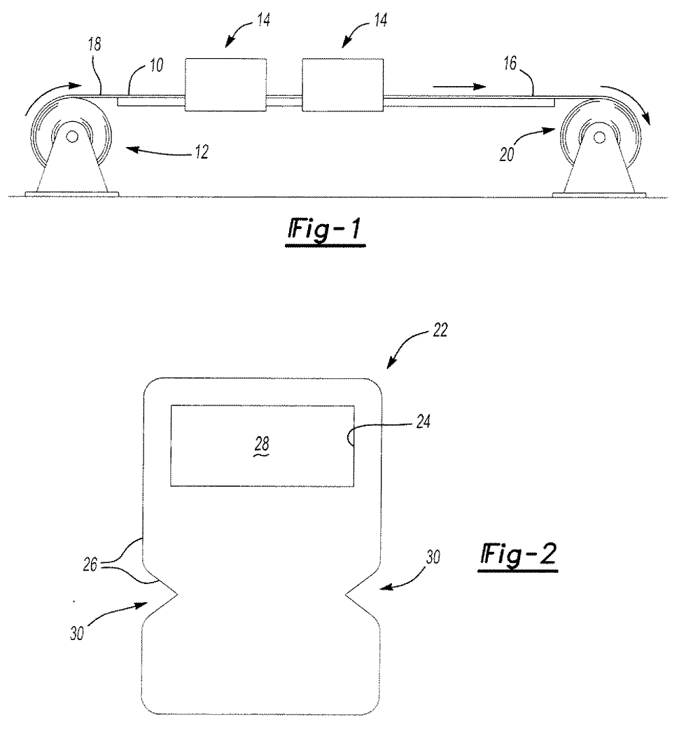

With reference to FIG. 1, fabric 10 from a roll 12 is being fed to one or more printing machines 14 such as screen printing machines, which continuously apply or print a polymeric and/or pigmented material 16 onto a surface 18 of the fabric 10 in a predetermined pattern. The material 16 is then typically allowed to dry and, in the embodiment shown, the fabric is re-assembled into a roll 20. During such a process, it can be desirable to maintain a relatively low and relatively uniform tension on the fabric during printing, although greater tension may be used.

Unless provided in a predetermined desired configuration, it is typically desirable to shape the layers of material into predetermined patterns to form shaped layers that can include, without limitation, peripheral edges, internal edges, and openings (e.g., cavities, through-holes, slits or the like). As used herein, peripheral edges are typically located at the outer boundaries of the shaped layers while internal edges are located substantially entirely inside the outer boundaries of the shaped layers. The openings can include cavities or contours defined by internal or peripheral edges or can include through-holes (e.g., slits) which are typically defined substantially entirely by internal edges. As an example, FIG. 2 illustrates a fabric layer 22 having internal edges 24 and peripheral edges 26. As shown, the internal edges 24 define a through-hole 28 through the layer 22 and the peripheral edges 26, in addition to defining the outer boundary of the layer 22 also define cavities 30 of the outer boundary.

It is also contemplated that an opening (e.g., a through-hole) may extend through one or more layers of the laminate without extending through one or more of the other layers of the laminate. As an example, an opening (e.g., a through-hole or cavity) in one layer could provide visual access to another layer.

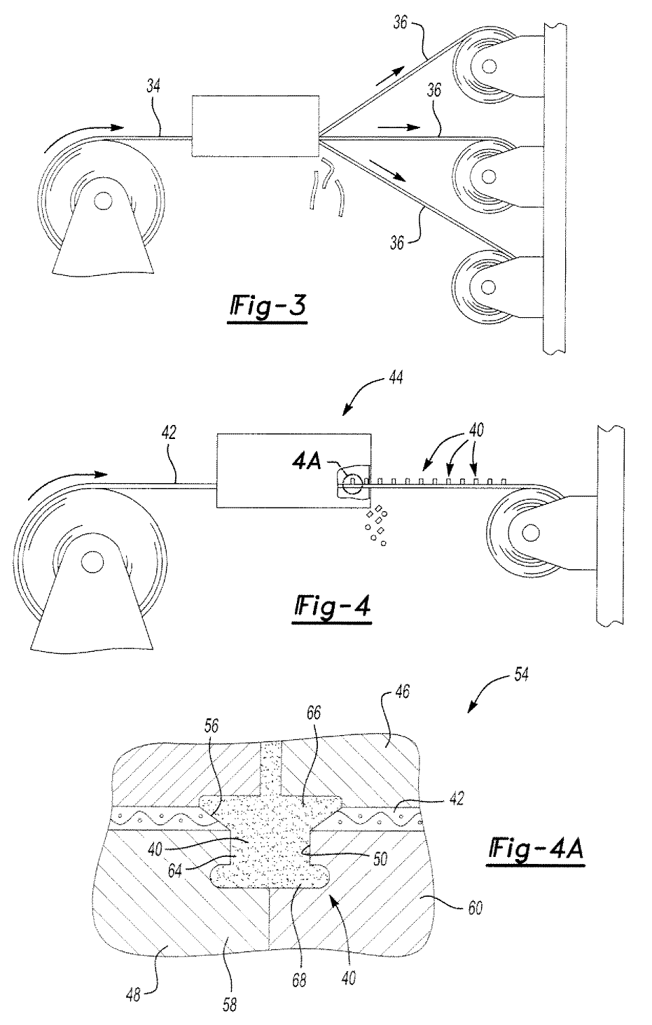

As part of the shaping process, larger layers of material may be cut or otherwise formed into smaller layers of material. The larger layer could be cut be cut at one or more locations along it thickness to form multiple thinner layers but is preferably cut at one or more locations along its width to forms multiple layers of smaller width. In FIG. 3, a layer 34 of material is provided as a roll and is cut at multiple location along its width into a plurality of layers 36 (e.g, widths) generally having a smaller width than the original larger layer 34 and the smaller layers are formed into rolls. In a preferred embodiment, a larger layer of printed fabric and a larger layer of unprinted fabric are each cut and divided into a plurality of sub-layers wherein the sub-layers of the printed fabric substantially correspond in width to the sub-layers of the non-printed fabric.

Attachments

Before, during or after shaping of the layers of the laminate and actual lamination of the layers, one or more attachments may be attached to one or more of the layers of the laminate. Generally it is contemplated that a variety of attachments such as adhesives, welds, mechanical fasteners, combinations thereof or the like may be employed together with the laminate of the present invention. Examples of suitable mechanical fasteners include, without limitation, protrusions, hooks, snaps, rivets, interlocking devices, hook and loop fasteners or the like, which can be interference fit, friction fit or otherwise fit to an article.

In one embodiment, a material such as a polymeric material is molded in such manner as to form and at least partially simultaneously attach one or more molded mechanical fasteners to one, two or more layers of the laminate. The fasteners according to the present invention can be prepared using various molding techniques. Exemplary molding techniques include without limitation, blow molding, injection molding, compression molding or the like. Such molded fasteners can be shaped as hooks, bulbs, protrusions or otherwise as needed or desired. Moreover, it is contemplated that it may be possible for the fasteners to be integrated with the laminate at the same time as the trim, which is discussed further below.

Thermosetting or thermosettable plastics, elastomers or combinations thereof can be employed to prepare the polymeric attachments using techniques such as reaction injection molding or resin transfer molding. In general, the attachments can be prepared from a broad range of plastic materials including thermoset plastics such as polyurethane, epoxy or thermosetting silicone and/or to thermoplastics such as polycarbonates (“PC”), ABS, polypropylene (“PP”), high impact polystyrene (“HIPS”), polyethylene (“PE”), polyester, polyacetyl, thermoplastic elastomers, thermoplastic polyurethanes (“TPU”), nylon, ionomer (e.g., Surlyn), polyvinyl chloride (“PVC”) and including blends of two or more of these thermoplastics such as PC and ABS. These materials may contain pigments, additives and/or fillers that contribute any needed cost and/or performance features such as surface appearance, ignition resistance, modulus, toughness, EMI shielding and the like.

In one preferred embodiment, the molded fasteners include a larger portion and a smaller portion such that the larger portion can be forced through an opening in an article of manufacture to interferingly fit the fastener to the article. In such an embodiment, it can be desirable for the material used to form the fastener to include elastomer such that the larger portion of the fastener can be compressed and forced through the opening in the article of manufacture and subsequently expand to interferingly fit the fastener to the article.

With reference to FIG. 4, multiple fasteners 40 are injection molded such that the fasteners attach (e.g., adhere) to a layer 42. The layer 42 can be any of the layers discussed herein, but in one preferred embodiment, it is a layer formed during the cutting process of FIG. 3.

The fasteners 40 are formed by locating the layer 42 in a mold of an injection molding machine 44. As shown in FIG. 4A, the layer 42 is located between a first die 46 and second die 48 that cooperatively form a cavity 50 in the desired shape of the fastener 40. Thereafter, the polymeric material of the fastener 40 is injected into the mold 54 to form the fastener 40 in the desired shape. In the embodiment shown, injection of the material into the mold 54 forms an opening 56 (e.g., through-hole) in the layer 42 through which the material flows, although such an opening could be pre-formed if desired.

Once the fastener 40 is formed, the mold 54 is removed from about the fastener 40 by moving the first die 46 away from the second die 48 and moving a first section 58 of the second die 48 away from a second section 60 of the second die 48. This process can be repeated or applied simultaneously to form multiple fasteners. As shown, the fastener 40 is formed to have a relatively small diameter portion 64 interconnecting a relatively larger base portion 66 and a relatively larger to diameter portion 68.

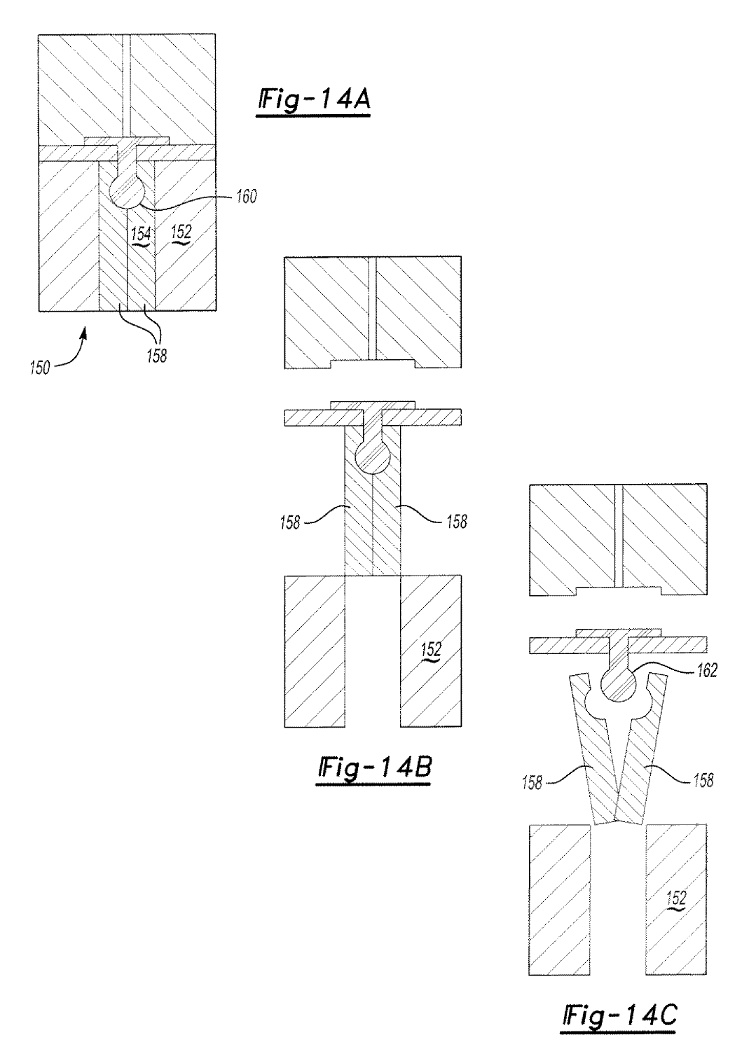

In another embodiment, a mold having an expansible core die is employed. As can be seen in FIGS. 14A-14C, a mold similar to that shown in FIG. 4A is used, however, the mold includes a second die 150 having an outer portion 152 that substantially surround and inner portion 154. As shown, the inner portion 154 includes a plurality of members 158 that cooperatively define an opening or cavity 160 in the shape of the fastener 162. Once the polymeric material has been injected in the cavity 160 and the fastener 162 is formed, the outer portion 152 can be removed from about the inner portion 154 such that the members 158 of the inner portion 154 can be removed from about the fastener 162.

Lamination

Lamination of the two or more layers typically includes locating the layers in a generally coextensive relationship with each other and attaching the layers together using one or more techniques. The layers may be attached to each other using adhesive, one or more fasteners, one or more welds, melt sealing or adhesion, combinations thereof or the like. Other suitable processes for lamination include, without limitation, radio frequency (RF) welding, sonic welding, flame lamination, adhesive bonding, electromagnetic radiation bonding, or thermally initiated adhesive such as Dow Adhesive Film or other processes as will be recognized by the skilled artisan. Examples of desirable adhesives include epoxy, polyurethane, polyester or other adhesive materials.

According to one preferred embodiment, a laminate is formed by adhesively securing a first layer to a second layer with a layer of adhesive that is located between and/or is substantially co-extensive with the first layer and the second layer. Typically, although not required, a level of force or pressure is applied to the first and second layer urging the layers toward each other and assisting in further securing the adhesive to the layers.

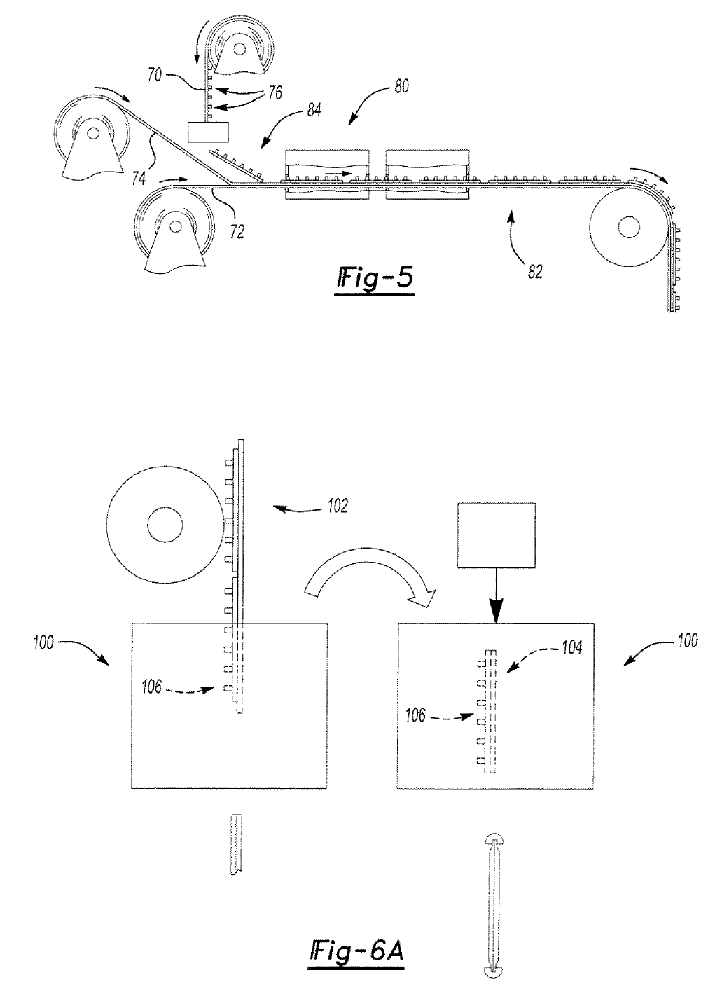

In FIG. 5, a first layer 70, a second layer 72 and an adhesive layer 74 are provided as rolls. In the embodiment shown, the first layer 70 is provided with fasteners 76 such as those discussed in relation to FIG. 4. The second layer 72 is provided as a printed fabric having a desired design. It should be understood that each of the layers 70, 72 could be smaller layers cut from original layers as discussed in relation to FIG. 3.

Each of the layers 70, 72, 74 is continuously fed to a press 80 with the adhesive layer 74 located between the first layer 70 and the second layer 72. As shown, the fasteners 76 extend outwardly from the laminate 82 and the base portion 66 of each of the fasteners 76 is at least partially located between the layers 70, 72. In a preferred embodiment, as part of the laminate shaping, the first layer 70 is shaped (e.g., cut) into sections 89 and located upon the adhesive layer 74 and the second layer 72 before it is fed to the press 80. In such an embodiment, it can be desirable to locate the printed design of the second layer 72 with at least some degree of precision relative to the fasteners 76 and/or the first layer 70.

According to one embodiment, a relatively precise alignment of the layers relative to each other can be accomplished through the use of fiducials. For example, one of the layers can include openings (e.g., through-holes) that align with printed markings (e.g., dots) on the other layer. Such markings, openings or both can be detected, aligned or both through the use of a detector such as a vision system and a alignment machine such as a mechanical x, y, theta registration system. Once the layers have been properly located or aligned, the press 80 applies heat and pressure to the laminate 82 to assist in ensuring greater adhesion between the layers 70, 72. The laminate 82 can also be welded (e.g., radio frequency welded).

While, as suggested, the peripheral edges, internal edges or both may be formed before, during or after any of the processing steps discussed herein, it has been found to be convenient to form some or all of these edges after lamination. As an example, the laminate can be cut (e.g., die cut) to include the internal and peripheral edges as were discussed above in relation to FIG. 2. Generally, these edges can be defined by the layers of the laminate or, in instances where trim has been molded upon the layers, such edges will typically be defined by the trim.

Molding of Trim

When included, it is contemplated that trim may be disposed upon the laminate structure using a variety of techniques which can include manual or automated techniques of disposing trim material upon edges or other locations of the laminate. Preferably, the trim material is a polymeric material that is molded upon the edges of one or more layers. Multiple molding techniques can be used. Exemplary molding techniques include, without limitation, injection molding, compression molding, thermoforming, reaction injection molding, resin transfer molding, injection compression molding, gas assist injection molding, structural foam injection molding, microcellular foam molding technology, lamellar injection molding, water injection molding, external gas molding, shear controlled orientation molding, and gas counter pressure injection molding or the like. Moreover, these techniques can be used to impart a smooth or textured surface to the trim material.

Thermosetting, thermosettable and/or thermoplastic polymeric materials (e.g., plastics, elastomers or both) can be used to form the trim. Moreover, the trim can be prepared from a broad range of plastic materials including thermoset plastics such as polyurethane, epoxy or thermosetting silicone and thermoplastics such as polycarbonates (“PC”), ABS, polypropylene (“PP”), high impact polystyrene (“HIPS”), polyethylene (“PE”), polyester, polyacetyl, thermoplastic elastomers, thermoplastic polyurethanes (“TPU”), nylon, ionomer (e.g., Surlyn), polyvinyl chloride (“PVC”) and including blends of two or more of these thermoplastics such as PC and ABS. These materials may contain pigments, additives and/or fillers that contribute any needed cost and/or performance features such as surface appearance, ignition resistance, modulus, toughness, EMI shielding and the like. The trim material may be partially the same as, substantially exactly the same as or different than the material used for the attachments.

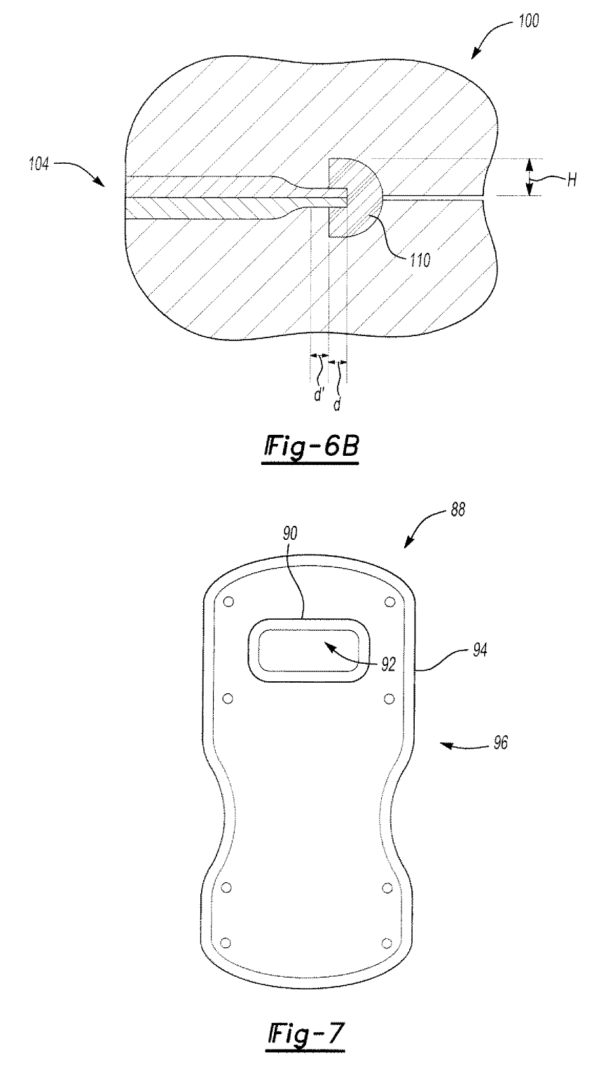

FIG. 7 illustrates a laminate structure 88 having internal polymeric trim 90 extending about and forming internal edges 92 of the laminate 88 and peripheral polymeric trim 94 extending about and forming peripheral edges 96. The trim 90 94 can be applied using an injection molding technique illustrated in FIG. 6.

In particular, a laminate such as the laminate formed in FIG. 5 can be fed to a molding tool 100 (e.g., injection molding tool) as shown in FIG. 6A. The laminate 102 can be aligned and registered in the tool and the tool can be closed to cut away material of the laminate 102 that is not to be part of the end product with subsequent opening of the tool and removal of the excess laminate. A laminate piece 104 having the desired shape is then left within the tool 100. Of course, the laminate 102 may be pre-cut to a desired shape like the laminate piece 104 prior to location of the laminate 102 within the tools. Advantageously, location of attachments 106 within openings in the tool can assist in aligning and registering the laminate 102 and/or laminate piece 104.

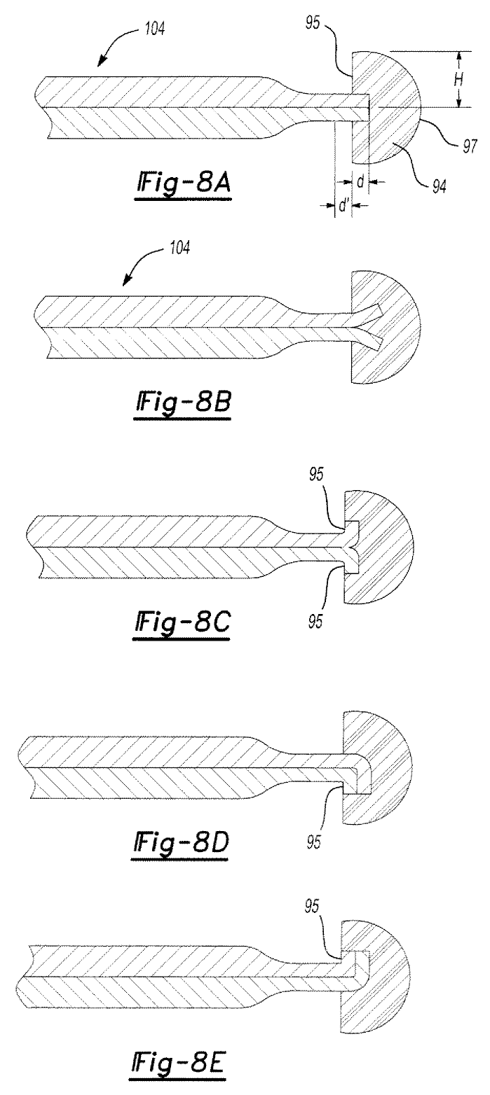

Once the laminate piece 104 with the desired configuration is located within the tool 100 and the tool 100 is or remains closed such that, edges of the laminate piece typically extend into openings 110 of the tool 100 as shown in FIG. 6A. The polymeric trim material is then injected into the openings 110 such that the material forms the trim 90, 94 as shown in FIGS. 7 and 8A. Preferably, as shown in FIG. 8A, the polymeric trim 90, 94 encases edges of the laminate piece 104 and adheres to the edges of the laminate piece 104.

In the embodiment illustrated, the trim 90, 94 has a substantially planar surface or surfaces 95 and contoured (e.g., concave or arced) surface 97. As shown, the planar surface[s] 95 face inwardly toward the rest of the laminate piece104 and the contoured surface[s] 97 faces outwardly away from the rest of the laminate piece 104 and/or defines the periphery of the trim 90, 94, the laminate piece 104 or both. The trim 94 of FIG. 8A is D-shaped in cross-section.

The mold opening 110, the trim 90, 94 or both typically define at least two dimensions, a height (H) and a dimension (d). The height (H) is defined as the distance from the center of laminate piece 104 at a location of entry into the substantially planar surface[s] 95 to the contoured surface[s] 97 where it intersects the substantially planar surface[s] 95. The dimension (d) is the distance that the laminate piece 104 or a layer thereof extends into the trim 90, 94 past the substantially planar surface[s] 95. Height (H) is typically at least 0.01 mm greater, although possibly less, more typically at least 0.20 mm greater, and even possibly at least 0.5 mm greater than dimension (d). Height (H) is typically between about 0.01 mm and about 10 mm, although possibly higher or lower, more typically between about 0.1 mm and about 2 mm and even more typically between about 0.45 mm and about 0.65 mm. Dimension (d) is typically less than about 2 mm, although possibly more, more typically less than about 0.7 mm and even more typically less than about 0.44 or even 0.35 mm. Dimension (d) can even be negative (i.e., the polymeric trim material can extend outwardly from the substantially planar surface[s] 95) to contact the laminate piece 104) but is typically greater than −2.0 mm, although possibly less, more typically greater than −1 mm and even more typically greater than −0.5 mm.

It should be understood that the dimensions provided above are for one preferred embodiment. However, depending upon the desired use of the laminate, the trim could be substantially larger or could be smaller.

In one embodiment, the polymeric trim material is injected into the tool at a temperature sufficient to de-laminate the edges of the laminate piece 104 as illustrated in FIG. 8B. It has been found that such de-lamination can allow for more robust adhesion of the trim material to the laminate piece particularly where the adhesive of the laminate piece is chemically compatible with the trim material. In such an embodiment the dimension (d) can be determined as the furthest distance that any one or more layers of the laminate piece extend into the trim.

In certain embodiments, it can be desirable to further press and/or thin the edges or other portions of the laminate. For example, it may be desirable to RF weld or coin edges of the laminate that are to be attached to trim material. Such pressing or thinning, unless otherwise stated, is not required.

It is also possible that, during injection, one or more of the layers of the laminate piece is moved such that the layer[s] forms the substantially planar surface[s] 95 as shown in FIGS. 8C-E. In such an embodiment, the dimension (d) would be the greatest distance that the one or more layers extend along the substantially planar surface[s].

In addition to the above, it is contemplated that the trim of the laminate structure may be shaped to include one or more protrusions or cavities that can assist in attaching the laminate to an article of manufacture. For example, the article of manufacture can include openings (e.g., through-hole or cavities) suitable for receiving protrusions molded into the trim. As an alternative, the article of manufacture could include one or more protrusions and the trim could be configured to include one or more openings (e.g., through-holes or cavities) suitable for receiving the protrusions. Of course, combinations of the above may also be employed.

Regardless of which of the articles or trim includes the protrusions or cavities, it is typically desirable, when such are included, for the protrusions to be relatively securely fit within the openings. Such a fit can be an interference fit, a compression fit, a friction fit or a combination thereof.

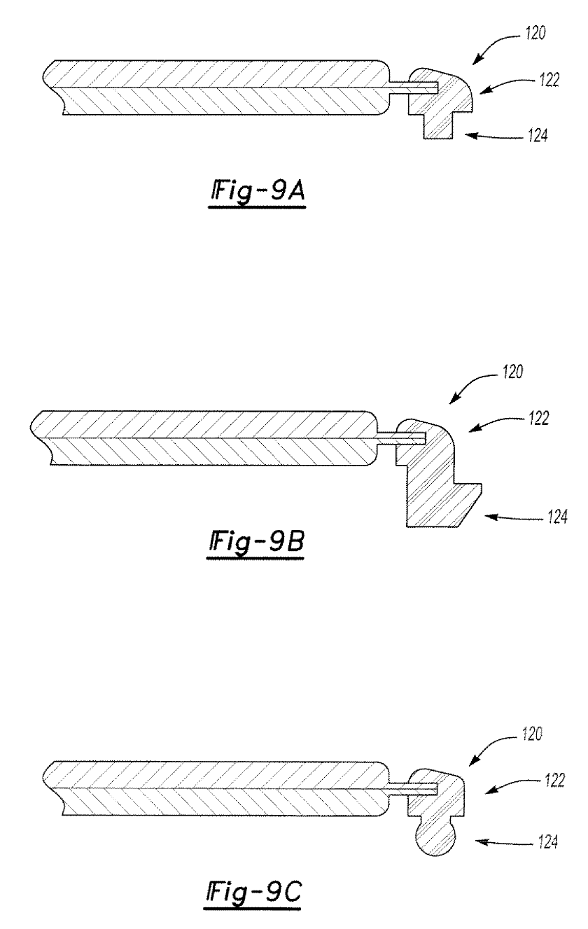

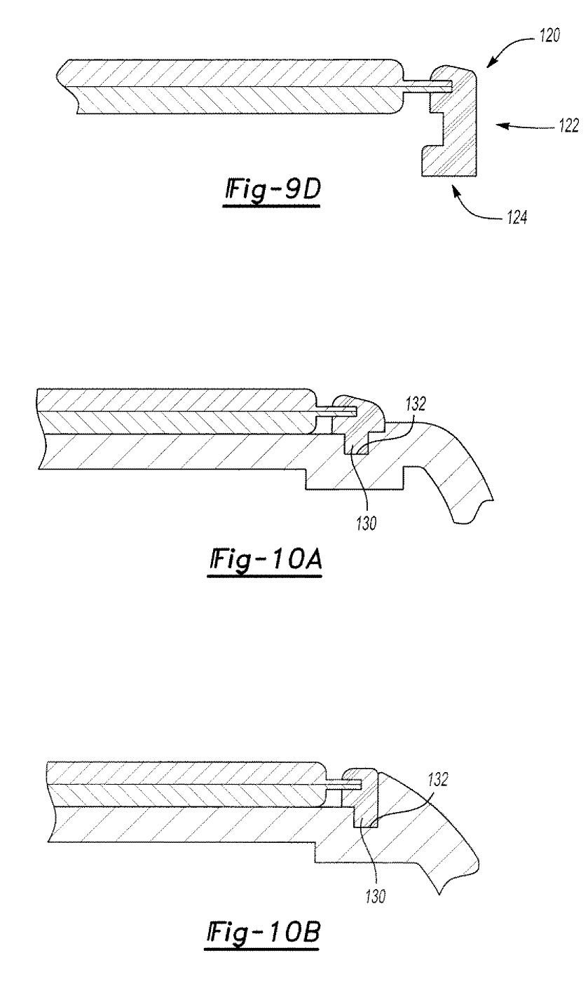

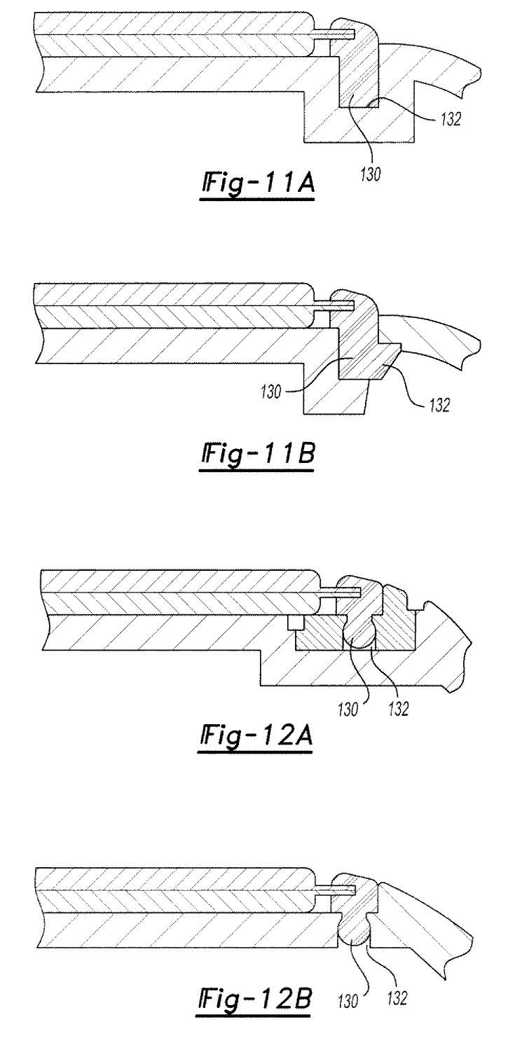

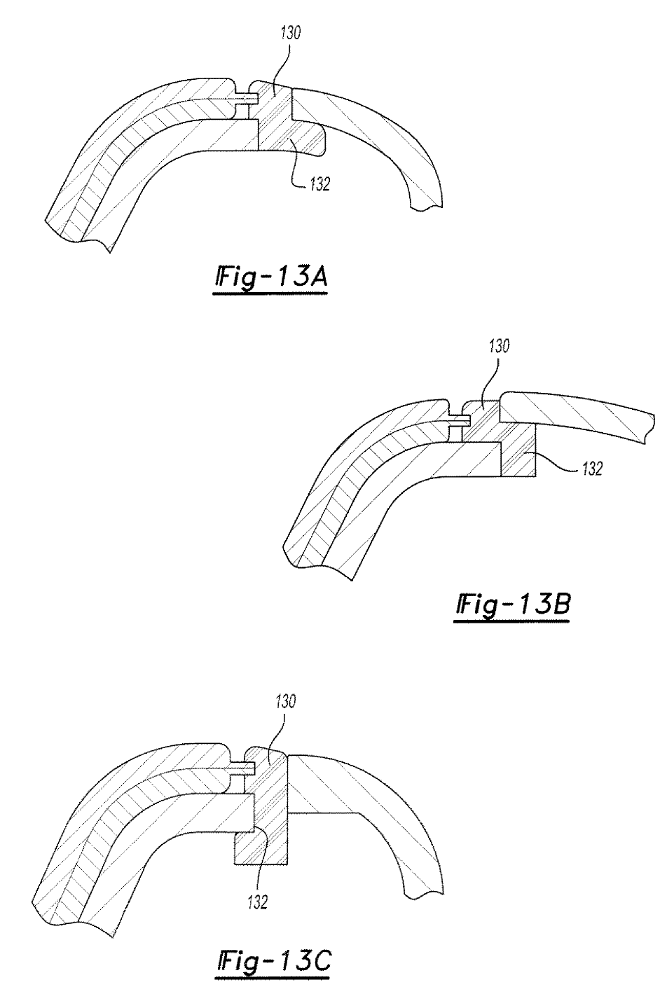

FIGS. 9A-9D illustrate examples of trim 120 that is molded in a shape suitable for attachment to an article of manufacture. As can be seen, each example of trim 120 includes a base portion 122 and a protrusion 124 extending therefrom. FIGS. 10A-13C show protrusions 130 of trim that are received in openings 132 of articles of manufacture.

### EXAMPLES

### Example 1

A part according to the present invention as shown in FIG. 7 can be designed and produced generally as shown in FIGS. 1 through 6A and 14C-14C and discussed above. The fabric can be micro fiber polyester suede having a thickness of approximately 0.6 mm. One wide roll of fabric is unwound and fed into a printing and heat curing line. A predetermined pattern is screen printed on the fabric and subsequently heat cured and rewound onto a core. The wide roll of the printed fabric and a wide roll of the unprinted fabric are slit to form multiple narrow rolls.

The unprinted fabric narrow roll is unwound and indexed through a two station tool in an injection molding machine. Holes are punched in the first station to aid registration in later steps of the process. The mold is opened and the fabric section is indexed from the punching station to the injection molding station. The fabric section is registered with the injection molding station of the tool, the mold is closed, and nylon material is injected at a temperature of 650 F at multiple locations on one side of the fabric. The molten nylon is injected through the fabric layer and fills cavity portions on each side of the fabric material forming fasteners with plate-like bases on one side of the fabric and the bulb of the popper on the opposite side of the fabric. Additionally, nylon grommets are molded onto the fabric at the 4 corners of the molding station. These grommets will facilitate registration in subsequent steps. The fabric continues indexing through this process and is rewound into a roll.

The rolls of printed fabric and rolls of unprinted fabric with popper fasteners are unwound and indexed through the laminator. The printed fabric is unwound and indexed through a laminating station with its printed side down. A 0.001 inch thermally activated thermoplastic polyurethane adhesive film with a release layer is unwound and the release layer is peeled off and collected on a rewind core. The adhesive film is indexed through the laminating station on top of the printed fabric. The poppered fabric is unwound and fed into a sheeting station with the popper bulb side of the fabric facing up. A 10-inch length of the poppered fabric is cut from the roll, transferred to the laminating station, registered with the printed fabric and the 3 layers are laminated together in the lamination station at a temperature of 120 C between flat plates for 30 seconds forming a laminated fabric structure. The laminated fabric structure continues indexing through the machine and is collected onto a rewind core.

The laminated fabric is unwound and indexed through a second tool in an injection molding machine. The laminated fabric is indexed and registered in the cutting station of the tool. The tool closes, the poppers engage into holes in the tool and multiple pieces with predetermined perimeter and holes are cut from the laminated fabric web. The tool is opened and the pieces cut out of the fabric web are retained on one side of the tool by the poppers that are engaged in the holes in that side of the tool. The remaining extra fabric is indexed and subsequently collected on a rewind core.

The side of the tool with the cut out pieces rotates moving the cut out pieces to the molding station of the tool. The mold is again closed cutting out another set of pieces in the cutting station and molding a trim of molten TPU plastic at a temperature of 500 F around the perimeter and internal hole edges of the pieces cut out in the previous station. The TPU plastic trim bonds to both of the fabric layer edges creating a durable and aesthetically pleasing appearance. The mold is opened and the first side is rotated back to its original position. The pieces with the trim molded around the edges are stripped off the tool and are the resulting parts made by this process. The mold closes again and the process repeats. The parts so made by this process have a precisely located and registered printed pattern on one side and precisely located and registered popper snap fastener features on the reverse side. The popper fasteners may be snapped into corresponding holes of the receiving housing of an article of manufacture (e.g., a wireless phone) such that the printed side of the fabric parts or covers will show.

### Example 2

A part is “insert” injection molded. An insert includes a laminate with layers of fabric, foam, and a relatively rigid plastic backer. From the injection molding step the insert edges are captured and finished in the molded plastic trim, which is a 40 mm diameter ring, 3 mm thick and the plastic used is PC/ABS. The fabric insert of the part rebounds (e.g., through foam expansion) to a greater thickness and can extend higher than the surrounding molded plastic such that the fabric insert provides a dome shape. Moreover, the part can be soft and cushioned because of the foam. On the back side of the part the relatively rigid backer adds stiffness and holds the part shape.

The injection mold for this part shuts-off or seals around the plastic being injected and clamps-up on the fabric laminate insert. The clamp-up pressure applied to the insert is such that the injected plastic does not penetrate or intrude into the laminate. This clamp-up pressure can be adjusted so that it is not so great as to damage the laminate structure.

For forming the insert, the insert materials are laminated together to form a laminate that is cut to the proper size. The insert is placed into the mold precisely by using locating features in the mold core followed by clamp-up of the insert and molding of the trim to form the part. The interior portion of the part is not subjected to the injection molding pressures which might otherwise damage the cell structure of the foam and in some cases the fabric.

As alternatives or additions to this example, the materials of construction can include fabric and backer, which can both be rigid or flexible and could be wood or metal. Moreover, both sides of the insert/part could be fabric. The injected molded plastic could also be rigid or flexible. These combinations would typically depend on the application.

### Additional Embodiments

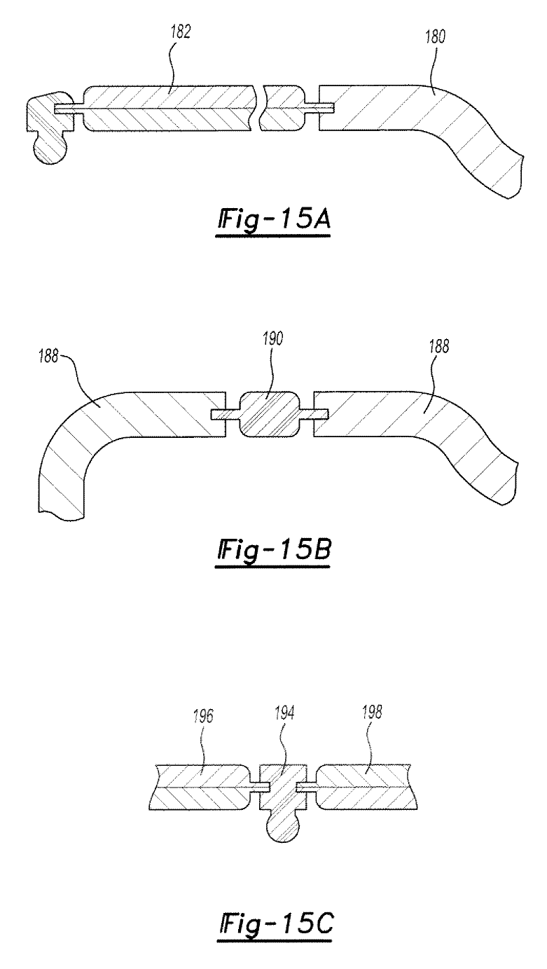

FIGS. 15A-15C show additional embodiments substrates that can be formed in accordance with the above teachings. As shown in 15A, it is possible that larger amounts of trim 180 can be formed and attached to a layer or laminate 182 of the present invention and the trim 180 can comprise a substantial portion of a covering of the present invention. In FIG. 15A, the trim 180 itself forms a layer that extends outwardly from the edge of the laminate 182. In FIG. 15B, trim layers 188 extend outwardly from opposite edges of a layer or laminate 190. Moreover, as shown in FIG. 15C, a single piece of trim 194, which may or may not include an integral fastener, can be attached to plural (e.g., two, three or more) separate laminates 196, 198.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A covering, comprising
at least one layer of material; and
external peripheral trim molded about the at least one layer and forming a peripheral edge of the covering, the external trim having a substantially planar surface facing toward the layer of material and a contoured surface facing away from the layer of material, wherein,
i. the trim has a height (H) as measured from the center of the at least one layer of material to an interface between the substantially planar surface and the contoured surface;
ii. the trim has a dimension (d) measured as the distance that the at least one layer of material extends into the trim; and
iii. (H) is greater than (d).

2. A covering as in claim 1 wherein:
i. the at least one layer includes a plurality of layers laminated to each other and forming a laminate piece, the plurality of layers including a first layer and a second layer.

3. A covering as in claim 2 further comprising at least one molded polymeric fastener integrated with the plurality of layers and having a base portion at least partially between the first layer and the second layer.

4. A covering as in claim 1 wherein attachment features are molded into the external trim.

5. A covering as in claim 2 wherein the first layer and second layer extend at least partially separately into the external trim.

6. A covering as in claim 5 wherein the first layer is laminated to the second layer with an adhesive that is compatible with the external trim.

7. A covering as in claim 1 wherein the at least one layer includes an opening and internal trim is molded about an edge of the at least one layer and forms an internal peripheral edge of the covering.

8. A covering as in claim 1 wherein the at least one layer has a pattern printed thereon.

9. A covering as in claim 1 wherein the fasteners correspond to openings in a housing of an electronic article of manufacture.

10. A covering as in claim 9 wherein the electronic article of manufacture is a wireless or cellular phone.

11. A flexible covering for an article of manufacture, comprising:
a first fabric layer;
a second fabric layer laminated to the first layer for forming a laminate piece, the laminate piece defining a peripheral edge and an internal edge;
a peripheral polymeric trim extending about and encasing the peripheral edge of the fabric piece;
an internal polymeric trim extending about the internal edge of the fabric piece;
a plurality of molded polymeric fasteners extending from the laminate piece, each of the fasteners including a base portion at least partially between the first layer and the second layer,

12. A covering as in claim 11 wherein attachment features are molded into the external trim.

13. A covering as in claim 11 wherein the first layer and second layer extend at least partially separately into the external trim.

14. A covering as in claim 13 wherein the first layer is laminated to the second layer with an adhesive that is compatible with the external trim.

15. A covering as in claim 11 wherein the at least one layer has a pattern printed thereon.

16. A covering as in claim 1 1 wherein the fasteners correspond to openings in a housing of an electronic article of manufacture.

17. A covering as in claim 16 wherein the electronic article of manufacture is a wireless or cellular phone.

18. A process of forming a flexible covering for an article of manufacture, the process comprising:
providing at least one layer;
shaping the at least one layer to form a piece with a predefined peripheral edge; and
molding a polymeric trim about the peripheral edge such that a peripheral trim is formed about the peripheral edge.

19. A process as in claim 18 wherein:
i. the at least one layer includes a first fabric layer laminated to a second fabric layer and the piece is a laminate piece;
ii. upon molding of the polymeric trim, the first fabric layer de-laminates from the second polymeric layer at the edge of the laminate piece.

20. A process as in claim 19 wherein the piece includes one or more through-holes extending through the piece and the polymeric trim is also molded about an internal edge that forms the one or more through-holes.

21. A process as in claim 20 wherein an edge of each of the first and second fabrics is separately enveloped by the polymeric trim.

22. A process as in claim 19 further comprising screen printing a pattern upon the at least one layer.

23. A process as in claim 19 further comprising molding attachments to the at least one layer,

24. A process as in claim 19 further comprising molding attachments to the at least one layer by injecting polymeric material through the second layer.

25. A process as in claim 19 wherein the article of manufacture is a housing for an electronic device such as a wireless phone.
